(19) United States
(12) Patent Application Publication
(10) Pub. No.: US 2025/0251130 A1
(43) Pub. Date: Aug. 7, 2025

(54) Micro Gas Turbine Engine and Related Methods of Manufacture

(71) Applicant: Purdue Research Foundation, West Lafayette, IN (US)

(72) Inventor: Li QIAO, West Lafayette, IN (US)

(73) Assignee: Purdue Research Foundation, West Lafayette, IN (US)

(21) Appl. No.: 18/616,028

(22) Filed: Mar. 25, 2024

Related U.S. Application Data
(60) Provisional application No. 63/454,506, filed on Mar. 24, 2023.

(51) Int. Cl. F23R 3/00; B28B 1/00; B33Y 80/00; F02C 3/00; F02C 7/12; F02C 7/22

(52) U.S. Cl. CPC F23R 3/002; B28B 1/001; B33Y 80/00; F02C 3/00; F02C 7/12; F02C 7/22; F05D 2230/31; F23R 2900/00018

(57) ABSTRACT

A micro gas turbine engine may include a single-piece rotor having a compressor, a turbine, and a shaft manufactured from an additive manufacturing process. The compressor, turbine, and shaft are a single uniform piece and not separately joined together. The micro gas turbine engine may further include a ceramic cover having built in fuel injectors and stator blades for the compressor. The micro gas turbine engine may further include a inner combustor lining having built in stator blades for the turbine.

### CROSS REFERENCE TO RELATED APPLICATIONS

This application claims the benefit of U.S. Provisional Application No. 63/454,506 filed Mar. 24, 2023, the entirety of which is hereby incorporated by reference.

### GOVERNMENT FUNDING

This invention was made with government support under 2219674 awarded by the National Science Foundation. The government has certain rights in the invention.

### TECHNICAL FIELD

This disclosure relates to gas turbine engines and, in particular, micro gas turbine engines.

### BACKGROUND

Micro-gas turbines are small combustion gas turbines with power output historically ranging from 30 KW to over 200 kW. The scaling down of gas turbine technology impacts negatively the heat and combustion processes which reduces the turbine power output and efficiency. Hence micro-gas turbines often operate at very high shaft speed (up to 100 000 rpm) and use electronic power inverters for power conditioning to generate a.c. voltage and at grid frequency. Micro-gas turbines also offer the advantages of compact size, low weight per unit power, multi-fuel capability and ease of emissions control.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates an example of a micro gas turbine engine assembly.

FIG. 2 illustrates a side view of an example of a single-piece rotor.

FIG. 3 illustrates a cutaway view of an example of a single-piece rotor.

FIG. 4 illustrates a cutaway perspective view of an example of a single-piece rotor.

FIG. 5 illustrates a perspective view of an example of a ceramic cover.

FIG. 6 illustrates a side view of an example of a ceramic cover.

FIG. 7 illustrates a cutaway side-view of an example of a ceramic cover.

FIG. 8 illustrates a side view of an example of a combustion chamber liner.

FIG. 9 illustrates a cutaway side view of an example of a combustion chamber liner.

FIG. 10 illustrates a perspective view of an example of a combustion chamber liner.

FIG. 11 illustrates a top view of an example of a combustion chamber liner.

FIG. 12 illustrates an exploded view of an example of a micro-gas turbine assembly.

FIG. 13 illustrates predicted energy output of a micro-gas turbine engine using hydrogen, Jet-A, and high-energy density lithium-ion batteries.

FIG. 14 illustrates energy output plotted against weight for various fuels.

### DETAILED DESCRIPTION

There are multiple challenges when we scale down gas turbines (which means from meter-sized to centimeter-sized). Most the of the available micro gas turbine engines (jet-A, gasoline, or diesel) are designed for hobbyists. These engines can run for a brief period of 10-20 minutes, and the efficiency is very poor and not suitable or commercial platforms. Moreover, most hobbyist micro turbine gas engines require service after only a few hours of running (change/clean the components). This is not surprising, because when scaling down gas turbines, heat transfer leads to lower operating shaft speed and turbine inlet temperature, causing a very low overall cycle efficiency. Additionally, micro gas turbine engines that operate on liquid fuels such as Jet-A-liquid fuels require atomization (forming a spray of millions of tiny droplets under high-pressure conditions), which is very difficult to achieve in a small volume such as in the combustor of a micro gas turbine. Problems atomizing in a small volume causes incomplete combustion, lowering fuel efficiency and causing soot deposition on the combustor wall and other parts of the engine.

The disclosure herein provides technical advancements for small scale gas turbine engines. By way of example, a one-piece compressor & turbine with internal cooling, made of silicon nitride material using a 3-D printing technique, boosts performance and enhances fuel efficiency. Typical micro gas turbine engines rely on spinning at very high rotational speeds and operating at high temperatures, which both induce a lot of thermal stress and mechanical stress onto the components of the engine. Typical engine materials like steel and titanium would not be able to handle loads at this scale because they would not be able to have much cooling or stress relief. By 3D printing engine materials with an advanced silicon nitride process, the engine gains a very high temperature resistance and include complex geometries to help reduce the stresses. While silicon nitride is typically not used for large parts because of statistical imperfections, the small scale of the micro turbine engine described herein (a few centimeters) permits the use of silicon nitride will have fewer imperfections which gives it an excellent strength distribution. Furthermore, 3D printing allows for a single-piece compressor and turbine to have internal cooling vanes that traditional manufacturing cannot produce. The small scale of the product prevents traditional tools from being able to create the complex features we need on an internal part. However, 3D printing's layer-by-layer approach allows the ceramic rotor to print precision cooling vanes inside the rotor itself. These vanes relieve thermal stress from inside the rotor, allowing it to operate in extreme conditions.

Another example of a technical advancement provided by this disclosure is that the combustor may be designed specifically for hydrogen fuel to maintain stable and efficient combustion. Traditional liquid fuels like Jet-A and diesel have lower energy density than that hydrogen (mass-based). More importantly, they require atomization (forming a spray of tiny droplets for fast evaporation and gas-phase mixing), which is extremely difficult to achieve efficient atomization because of the small size of the combustor. Hydrogen fuel, either in the form of compressed gas or liquified, doesn't have such an issue. Moreover, hydrogen is a sustainable and clean fuel, which produces water only after combustion. This avoids both pollutant emissions as well as greenhouse gas emissions. While some gas turbine manufacturers, such as Rolls-Royces, Siemens, and Pratt-Whitney, are developing hydrogen turbojets and turbofans for commercial and military aircraft, MICRO gas turbines remains underdeveloped. The micro gas turbine technology according to various examples described herein is developed for hydrogen fuel and capable of producing electric power in the range of 1-10 KW.

It is important to note that engine design, especially combustor design, will be completely different for hydrogen fuel than for jet-A fuel. This is because, compared to jet fuels, hydrogen has unique combustion properties, e.g., fast reaction rate, high flame speed, wider flammability limits, etc. The manufacturing process for the engine leverages additive manufacturing to create internal structures for improved control over hydrogen's flame. Additional and alternative technical advancements are described herein.

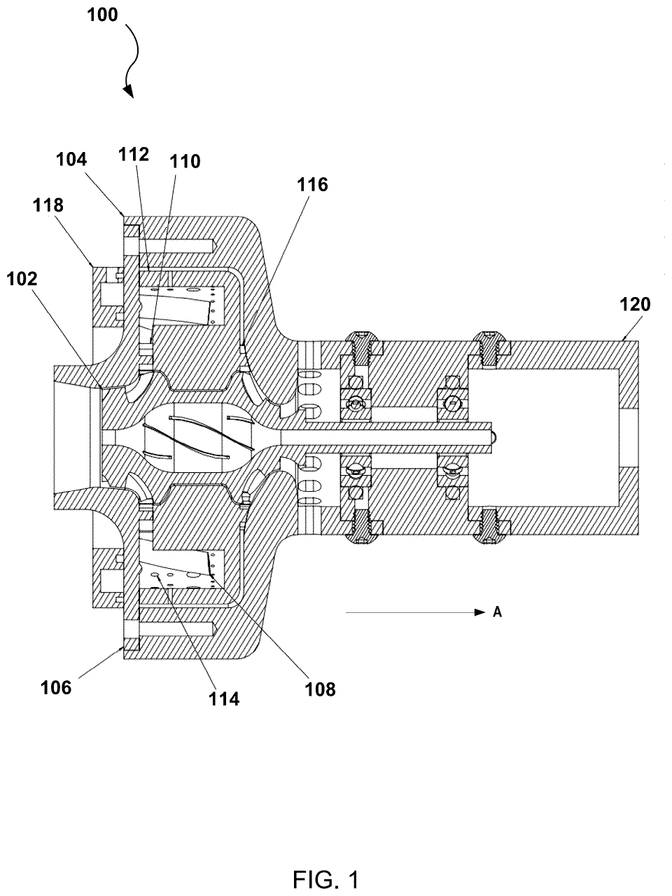

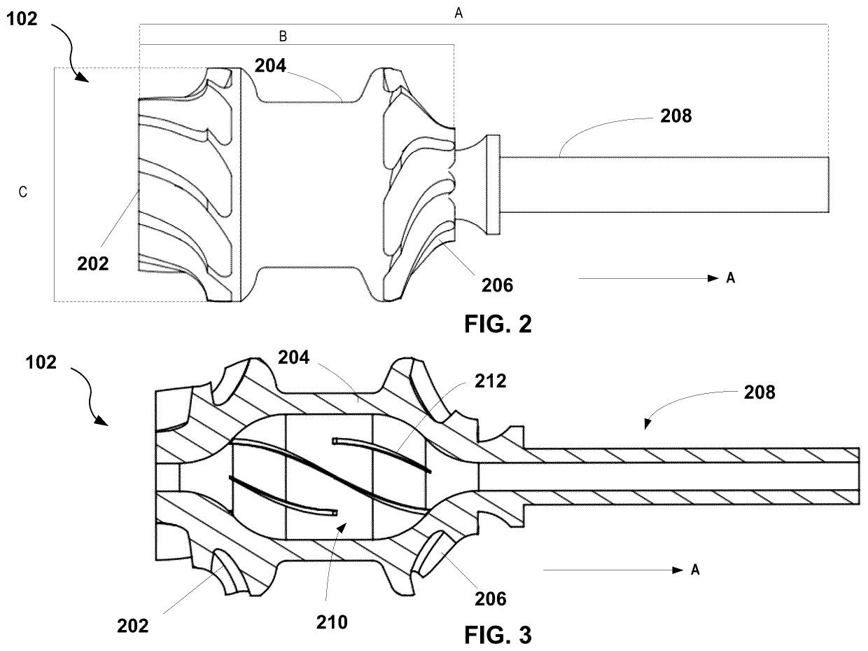

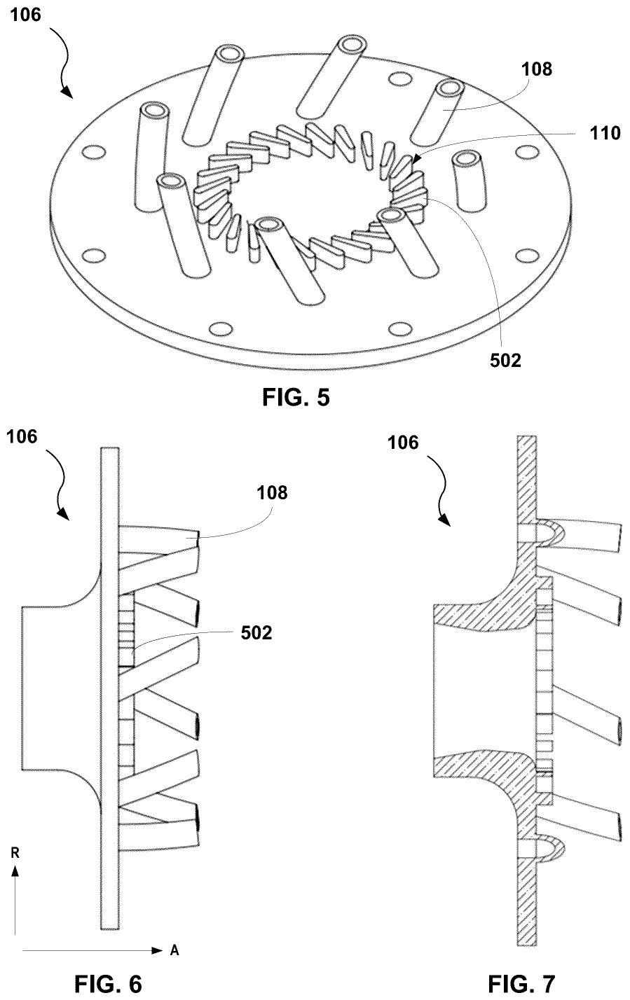

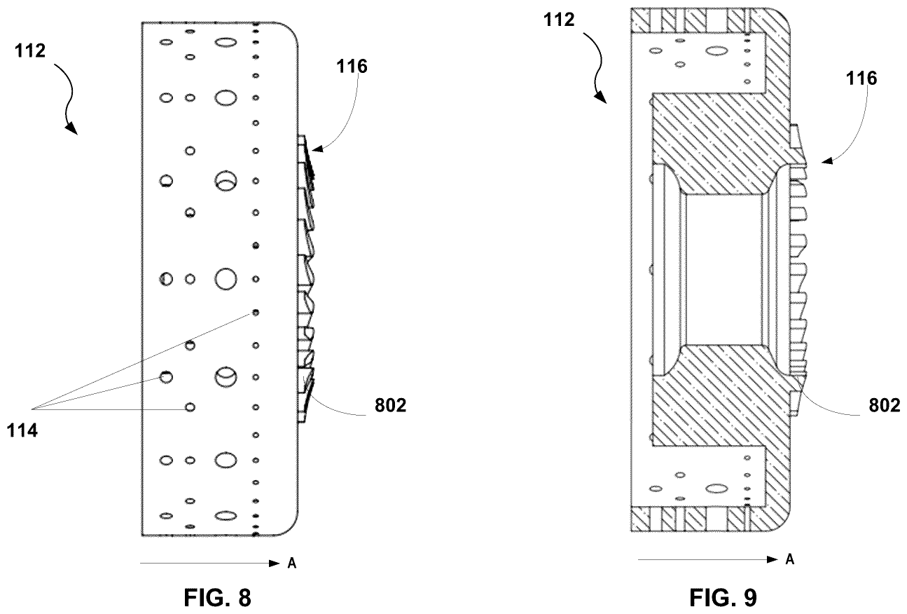

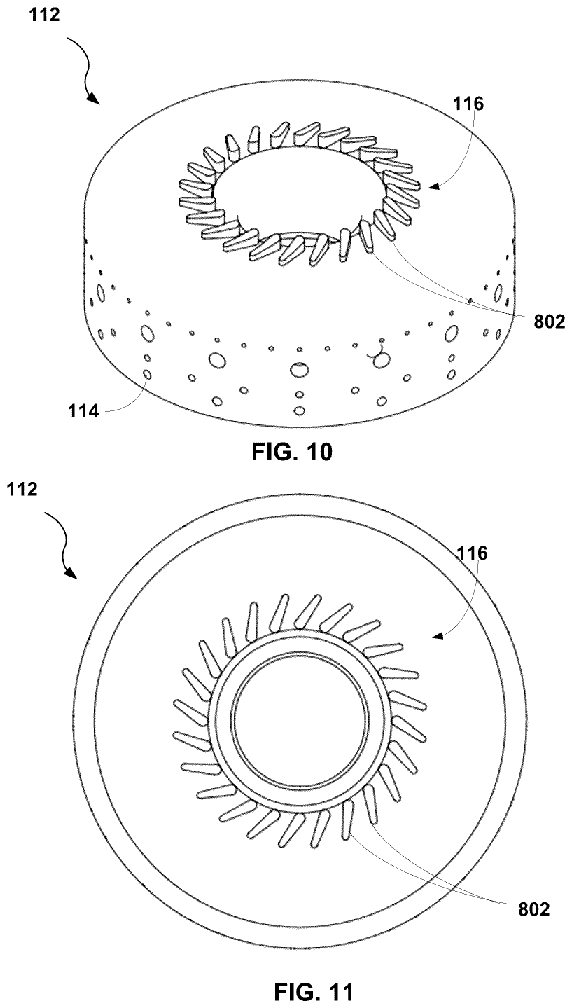

FIG. 1 illustrates a first example of a micro gas turbine engine assembly 100. The micro gas turbine engine assembly 100 may include a single piece compressor and turbine rotor (rotor) 102. An example rotor 102 is shown in FIGS. 2-4. The micro gas turbine engine assembly 100 may further include a ceramic housing 104, an example of which is shown in FIG. 10. The micro gas turbine may further include a ceramic cover 106, which, in some embodiments, may include fuel injectors 108 and stators 110. An example of the ceramic cover 106 is shown in FIGS. 5-7. The micro gas turbine engine may further include an inner combustor lining 112, which may include, some embodiments, dilution holes 114 and a stator 116. An example of the inner combustor lining 112 is shown in FIGS. 8-9. The micro gas turbine engine may further include a generator and bearing assembly 120.

According to some embodiments described herein, air is first taken in through the inlet ports of the ceramic housing 104. As the compressor spins, it draws in more air and compresses it to a higher pressure. The compressed air is then released into the inner combustor lining 112 where it meets hydrogen fuel injected from the hydrogen manifold 118. This air and fuel mixture is then combusted and goes to the turbine side of the single-piece rotor and out of the exhaust hole through the ceramic cover 106. The combusted air-fuel mixture drives the turbine while the excess energy is extracted into useable electric power.

The inter lining stator 116, which is positioned radially outward from the turbine, may be printed with the inner combustor lining 112 such that the inner lining stator 116 and combustor lining 112 are a single piece. The micro gas turbine engine may further include a ceramic cover stator 8, radially outward from the compressor. The ceramic cover stator 110, which is positioned radially outward of the compressor, may be printed with the ceramic cover 106 such that the ceramic cover stator 110 and ceramic cover 106 are a single piece.

In the past, it was not possible to perform this entire process on a small scale like that of the engine herein. However, due to the advanced capabilities of 3D printing silicon nitride, the technical advancements describe herein benefit from the very complex geometries and small scale made possible by the such printing techniques. Moreover, Silicon nitride can handle the extreme temperatures and stresses caused by the high rotation speed and combustion of the hydrogen-air mixture. The extreme energy density of hydrogen gas makes this an ideal candidate since it will make the entire system extremely lightweight and energy efficient.

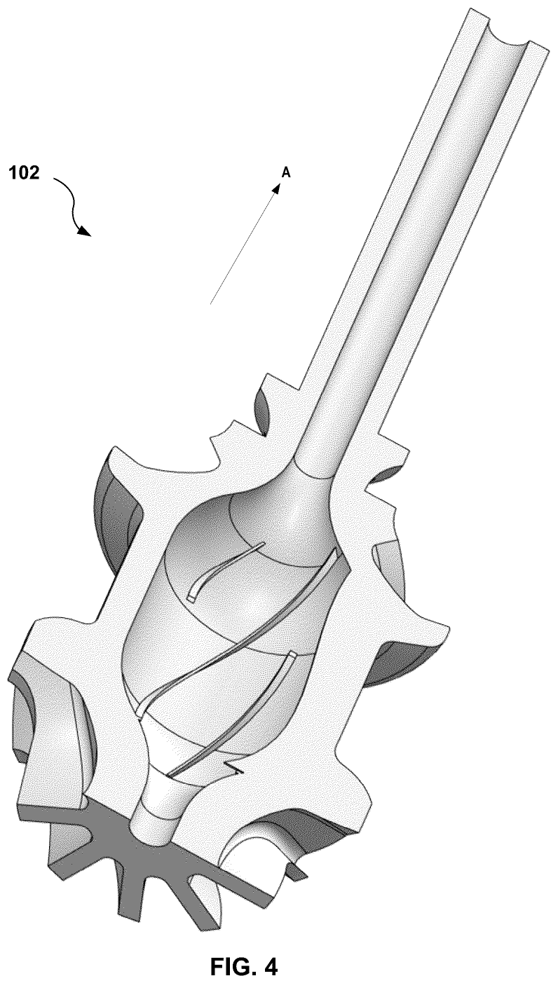

FIGS. 2-4 illustrate an example of the single-piece rotor 102. FIG. 2 illustrates a side view of the single-piece rotor 102. FIG. 3 illustrates a cutaway view of the single-piece rotor 102. FIG. 4 illustrates a cutaway perspective view of the single-piece rotor 102. Reference to FIG. 2-4 is made in the following discussion of the single piece rotor 102.

The single-piece rotor 102 may serve as the only rotating part of the micro-gas turbine engine assembly. The single piece rotor 102 may include a turbine 202, a hub 204, a compressor 206, and a shaft 208. The single piece rotor may be 3D printed as one piece. The blades on the turbine 202 and/or the compressor 206 may be optimized for ease of manufacturability and performance. In various examples, the length of the single piece rotor from end to end (dimension A in FIG. 2) may be 50 mm to 75 mm. The length between the turbine and rotor (dimension B in FIG. 3) may be 24 mm to 35 mm. The largest outer diameter (dimension C in FIG. 3) of the rotor may be 17 mm to 25 mm. It should be appreciated that these dimensions are non-limiting and are intended to show the small scale achievable by the additive manufacturing described herein. Smaller or larger dimensions are possible. Also, the “largest outer diameter” may be at other locations of the single-piece rother than shown in FIG. 2.

Similar to the other parts of a micro-gas turbine engine, traditional manufacturing is very difficult for the rotor 102. The blades do not leave enough room for tools to go in and generate the accurate shape needed to maintain a steady flow across both rotors. Complex fin geometries for producing air compression and turbine work extraction would be difficult with traditional machining or casting. If this were done on the larger scale of centimeters as opposed to millimeters (here, we are talking about the fin size/resolution of the compressor or turbine, which is only a few millimeters in our engine), we would be able to manufacture this with the traditional approaches. However, traditional approaches do not offer the thermal strength of 3D printer ceramic nor the precision and accuracy at the small scale we are working on. The overall scale is small so that the entire package will be lightweight and compact. Increasing the mass and package size of the engine will have detrimental effects as more power would be needed to carry this engine, which takes away from the desired endurance of the drone. A larger engine would also increase the lift and drag forces, not ideal for drones or small UAVs.

There are additional advancements for a micro-gas turbine described herein. Referring to FIG. 3, the single-piece rotor 102 may have a hollow interior central passage 210 defined by the hub that includes the turbine and compressor and the shaft. Thus the hollow interior central passage 210 may extend the length of the single piece rotor. In a counter flow design, air may travel along the interior from the turbine section toward the compressor section.

The walls of the single-piece rotor 102 may include cooling vanes 212. For example, the hub in FIG. 3 and FIG. 4 have cooling vanes 212 that extend between the turbine 202 and compressor 206. The cooling vanes 212 may protrude from an inner wall of the hub 204 and follow a helix path along an axial direction A.

The cooling vanes 212 may be formed as part of the additive manufacturing process of the single-piece rotor. The additive manufacturing may allow for cooling vanes to have small dimensions. For example, the width of a cooling vane may be 0.10 mm-0.25 mm, and the height (the distance the cooling vane protrudes from the inner hub wall) may be 0.25 mm-0.50 mm. The aforementioned ranges for the width and height of the cooling vane are non-limiting and intended to demonstrate the small-scale achievable by additive manufacturing.

The one piece rotor 102 may comprise a plurality of layers bonded together via the additive manufacturing process. The additive manufacturing may involve printing layers of the one-piece rotor 102. Depending on the orientation of the printing nozzle and/or work piece, each layer may comprise a various portions of the one-piece rotor 102. In a first example, each layer may be added along a direction perpendicular to the axial direction A. A first layer may include a portion of the turbine, a second layer comprises a portion of the compressor, and a third layer comprises a portion of the shaft. Of course, the additive printing may be also occur in other work piece orientations. In some examples, at least one of the layers of the rotor 102 may further define the interior passage 210 and/or a cooling vain 212 in the interior passage 210. Alternatively or in addition, at least one layer may include a blade of the compressor 202 or a blade of the turbine 206.

FIGS. 5-7 illustrate a ceramic cover 106. FIG. 5 illustrates a perspective view of the ceramic cover 106. FIG. 6 illustrates a side view of the ceramic cover 106. FIG. 7 illustrates a cutaway side-view of the ceramic cover 106. The ceramic cover 106 may include embedded fuel injectors 108 and a turbine stator 110 including a plurality of blades 502. These fuel injectors 108 and turbine stator blades 502 take advantage of the ceramic 3D printing capabilities by including geometries that would prove difficult to produce with traditional machining. FGI.

Referring to FIGS. 6-7, the fuel injectors 108 may be curved or angled tubes that allow the hydrogen fuel to be injected into the combustion chamber at an angle without significant losses in pressure. By way of example, the fuel injectors may extend away from an outer surface of the ceramic cover 106 along an axial direction A. In addition, the fuel injector(s) 108 may extend along a radial direction R such that the outlet of the fuel injector 108 is angled with respect to the axial direction A. The angle may be achieved using a straight tube or by using a curved tube which gradually bends along the radial direction R. The angled injection improves the hydrogen-air mixture uniformity inside the combustion chamber. By improving the gas uniformity inside the combustion chamber, a hotter and more stable flame will be present inside.

The turbine stator blades 502 may extend away from the outer surface of the ceramic cover along the axial direction A. The inclusion of the turbine stator blades 502 primarily serve to redirect the flow towards the turbine rotor in as small of a package size as possible. Typical stators are built as their own parts but introduce a lot of excess weight and volume waste. By including the blades inside this small area, the volume of the engine is better optimized and weighs considerably less. This is all possible because the part is designed around the fact that it will be 3D printed with ceramics. The ceramic material will allow the parts to withstand high temperatures while the 3D printing method will allow for this geometry. Traditional manufacturing at a larger scale is possible. However, at a small scale like this, machining these injectors at a curved angle and the small stators would not be possible. The tools used for traditional machining would take a very long time and still not produce a precise result.

The ceramic cover 106 may comprise a plurality of layers bonded together via the additive manufacturing process. The additive manufacturing may involve printing layers of the ceramic cover 106. Depending on the orientation of the printing nozzle and the work piece, each layer may comprise a various portion of the ceramic cover 106. In a first example, each layer may be added along the axial direction A. At least one layer of the cover 106 may include a portion of a fuel injector 108 and/or one or more stator blades 502.

FIGS. 8-11 illustrates an example of a combustion chamber inner liner 112. FIG. 8 illustrates a side view of the combustion chamber liner 112. FIG. 9 illustrates a cutaway side view of the combustion chamber liner 112. FIG. 10 illustrates a perspective view of the combustion chamber liner 112. FIG. 11 illustrates a top view of the combustion chamber liner 112. The combustion chamber liner 112 may include a stator 116. The stator 116 may include blades 802 extending from an outer surface of the inner lining 112 along an axial direction A. Unlike the cover, these blades 112 are for the compressor of a micro-gas turbine engine. Additionally, the inner lining 112 may include a series of dilution holes 108 that control the air distribution which stabilizes the flame. The holes 114 may optimize in a way that the combustion chamber inner lining will hold a flame that is more fuel rich upstream of the flow and gradually grows lean downstream of the flow.

This design used intensive simulations to ensure that a high flame temperature that is both stable and maintained a safe distance away from the walls to ensure structural stability. The inner path allows for the single piece rotor to fit in precisely within. Similar to the other parts, the inner lining 112 would prove difficult to manufacture with traditional tools. The 3D printing process allows us to bypass it and produce an accurate and precise result that uses the optimized dilution hole and stator designs to create a high performing micro gas turbine engine.

The combustion chamber liner 112 may include a plurality of layers bonded together via the additive manufacturing process. The additive manufacturing may involve printing layers of the combustion chamber liner 112. Depending on the orientation of the printing nozzle and the work piece, each layer may comprise a different portion of the combustion chamber liner 112. In a first example, each layer may be added along the axial direction A. At least one layer of the cover 106 may at least partially define a dilution hole 114. Alternatively, at least one layer may at least partially defines the stator 116 or blades 802 of the stator 116.

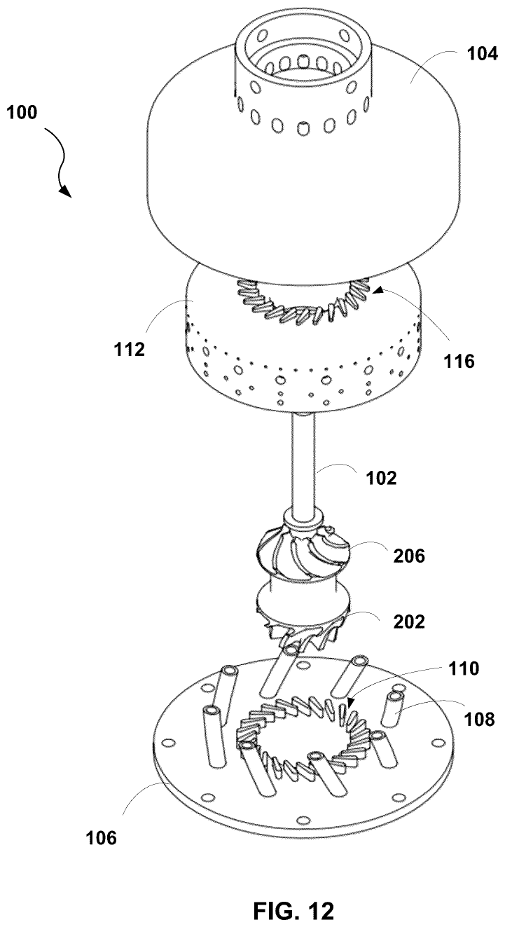

FIG. 12 illustrates an exploded view of the micro-gas turbine assembly 100. The single piece rotor 102 serves as the only rotating part of the entire assembly. By including both parts of the turbomachinery into a single piece, we significantly reduce the package size and weight that it introduces. This part is designed so that it can be 3D printed as one piece from the turbine side. The blades are optimized for ease of manufacturability and performance. Similar to the other parts, traditional manufacturing is very difficult here. The blades do not leave enough room for tools to go in and generate the accurate shape needed to maintain a steady flow across both rotors.

When the components are fastened together, the compressor 202 may be positioned radially inward of the cover stator 110, and the turbine 206 may be positioned radially inward of the inner liner stator 116. The fuel injectors 180 may extend into a space defined between the combustor liner 112 and the rotor 102.

Referring to both FIG. 1 and FIG. 12, to fasten the components together, the rotor 102 may be balanced on a double bearing system. The bearings nested in a generator assembly 120. The generator assembly 120 may be bolted together via socket head bolts. The combustor inner lining 112 may clamp onto the center of the rotor 102, pressed between the ceramic cover 106 and the ceramic housing 104. The hydrogen manifold 118, cover 106, and housing 104 may be fastened together with, for example, bolts.

Some or all of the components may be printed together using additive manufacturing and combined together. The additive manufacturing process used may include, by way of example, Ceramic DLP Slurry Vat Printing or Ceramic LCM Printing. The additive manufacturing may involve printing the inner combustor liner 112, the rotor 102, the cover 106, and/or the housing 104. The single piece rotor may be positioned a hole centrally positioned on the cover and within the inner combustor liner 112. The shaft may extend through a hole centrally located on the inner combustor liner 112 and a hole on the housing 104. The stator of the combustor liner may be positioned proximate to and radially outward form the turbine.

### Experimental Results

The following discussion provides experimental results for non-limiting examples and embodiments described herein.

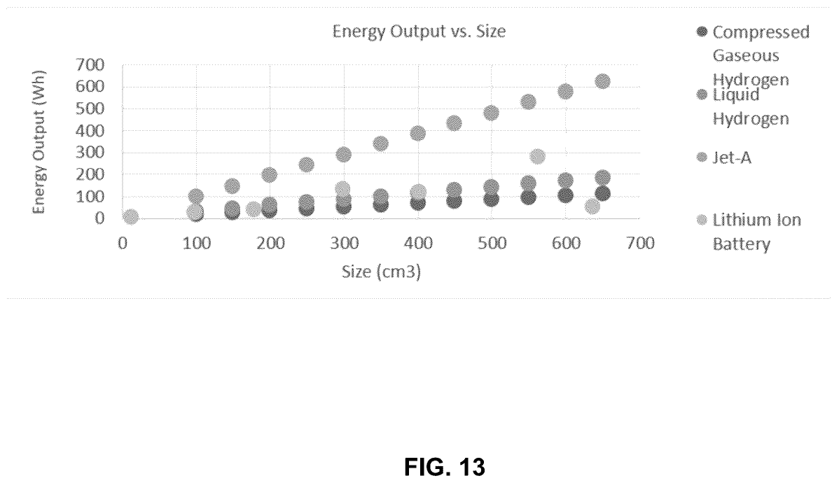

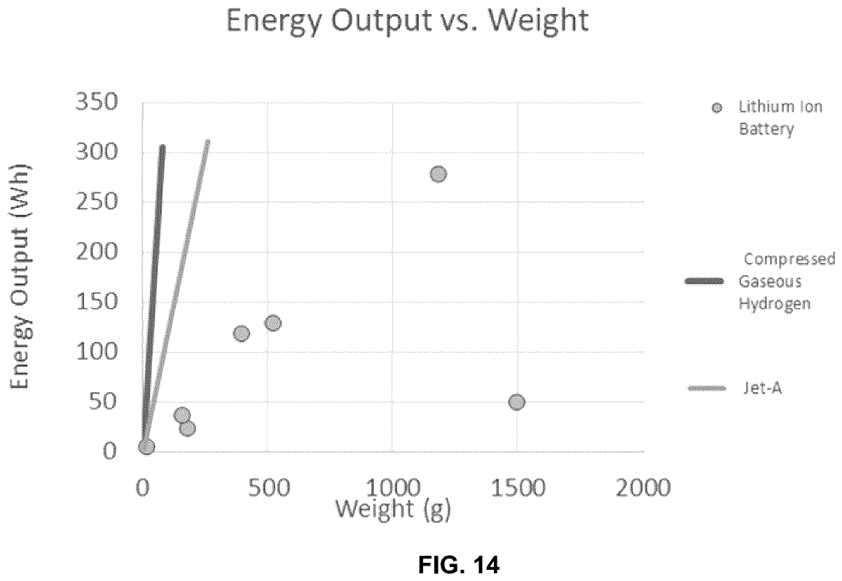

FIG. 13 illustrates predicted energy output in Wh of hydrogen, Jet-A, and high-energy density lithium-ion batteries. FIG. 14 illustrates energy output plotted against weight for various fuels. We can see that lithium-ion batteries get outperformed in both the volume and weight categories. However, Jet-A (a typical aircraft jet fuel) gets more energy in the same volume than hydrogen. It is important to note that although this occurs since hydrogen is not compressed easily, hydrogen significantly outperforms it in the mass category. For the same mass, hydrogen's energy density gives it more than three times the energy output as Jet-A. This is very important in this engine since the main factor that determines a drone's endurance is weight. Having a lower weight significantly increases endurance more than having a smaller volume does.

The micro gas turbine engine may be implemented with additional, different, or fewer components than illustrated. Each component may include additional, different, or fewer components. Moreover, in some components the single-piece rotor may be manufactured separately from other components of the micro gas turbine engine. The single-piece rotor may be assembled together with other components of the micro gas turbine engine.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the 10 second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations.

What is provisionally claimed is:

1. A micro gas turbine engine, comprising:
a single-piece rotor comprising a compressor, a turbine, and a shaft manufactured from an additive manufacturing process, wherein the compressor, turbine, and shaft are a single uniform piece and not separately joined together.

2. The micro gas turbine engine of claim 1, wherein the single piece rotor comprises a plurality of layers bonded together which form the compressor, turbine and shaft.

3. The micro gas turbine engine of claim 2, wherein the layers comprises a first layer, a second layer, and a third layer, wherein the first layer comprises at least a portion of the turbine, a second layer comprises at least a portion of the compressor, and a third portion comprises at least a portion of the shaft.

4. The micro gas turbine engine of claim 1, wherein the one-piece rotor comprises central passage that extends through the turbine, compressor, and shaft.

5. The micro gas turbine engine of claim 4, further comprising cooling vanes in the central passage.

6. The micro gas turbine engine of claim 5, wherein the cooling vanes protrude from a surface of the central passage.

7. The micro gas turbine engine of claim 6, wherein the cooling vanes protrude from the surface of the central passage a distance in a range of 0.25 mm to 0.50 mm.

8. The micro gas turbine engine of claim 6, wherein the cooling vanes have a width in a range of 0.10 mm to 0.25 mm.

9. The micro gas turbine engine of claim 6, wherein the cooling vanes follow a helical path along the surface of the central passage.

10. The micro gas turbine engine of claim 1, wherein the engine is configured to combust hydrogen fuel.

11. The micro gas turbine engine of claim 1, wherein the one-piece rotor comprises silicon nitride.

12. The micro gas turbine engine of claim 1, wherein the length of the one-piece rotor is in a range of 75 mm and 50 mm.

13. The micro gas turbine engine of claim 1, wherein a distance between the turbine and compressor of the one-piece rotor is in a range of 35 mm and 24 mm.

14. The micro gas turbine engine of claim 1, wherein the largest diameter of the single-piece rotor is in a range of 17 mm to 25 mm.

15. The micro gas turbine engine of claim 1, further comprising:
a combustor liner positioned radially outward from the single-piece rotor, the combustor liner having a first end and a second end;
a cover received by the first end of the combustor liner,
where the single-piece rotor extends through a central hole of the cover and inside of the liner.

16. The micro gas turbine of claim 15, wherein the cover comprises at least one for a group comprising a plurality of fuel injectors, a plurality of stator blades, or a combination thereof.

17. The micro gas turbine engine of claim 16, wherein the cover comprises a plurality of fuel injectors, wherein the fuel injectors comprise a plurality of tubes extending from a surface of the cover into a space between single-piece rotor and the combustor liner.

18. The micro gas turbine engine of claim 17, wherein the tubes extend along a direction that is not parallel with a centerline of single-piece rotor.

19. The micro gas turbine engine of claim 17, wherein the tubes are curved.

20. The micro gas turbine engine of claim 15, wherein the cover comprises a plurality of layers cured together as part of the additive manufacturing, wherein at least one of the layers comprise a portion of a first fuel injector and a portion of a second fuel injector.

21. The micro gas turbine engine of claim 15, wherein the cover comprises a plurality of layers cured together as part of the additive manufacturing, wherein at least one of the layers comprise a portion of a first stator and a portion of a second stator blade.

22. The micro gas turbine engine of claim 15, wherein the second end of the combustor liner comprises a plurality of stator blades positioned radially outward from the turbine.

23. A method of manufacturing a micro gas turbine engine, comprising:
printing, with additive manufacturing, layers of a one-piece rotor for a gas turbine engine, wherein a first layer comprises a portion of the turbine, a second layer comprises a portion of the compressor, and a third layer comprises a portion of the shaft.

24. The method of claim 23, wherein at least one of the layers further define a cooling vain in an interior passage of the rotor.

25. The method of claim 23, wherein the layers comprises silicon nitride.

26. The method of claim 23, wherein at least one layer comprises a blade of the compressor or a blade of the turbine.

27. The method of claim 23, further comprising:
printing, with the additive manufacturing, an inner combustor liner;
printing, with the additive manufacturing, a cover;
positioning single-piece rotor inside a hole centrally positioned on the cover and within the inner combustor liner; and
connecting the cover to an end of the combustor liner.

28. The method of claim 27, wherein printing, with the additive manufacturing, the cover further comprises:
at least one layer of the cover that comprises a portion of a fuel injector, a portion of a stator, or a combination thereof.

29. The method of claim 27, wherein printing, with the additive manufacturing, the inner combustor liner:
printing at least one layer of the combustor liner that at least partially defines a dilution hole.

30. The method of claim 27, wherein printing, with the additive manufacturing, the inner combustor liner further comprises:
printing at least one layer that at least partially defines a stator.

31. The method of claim 23, where the additive manufacturing comprises Ceramic DLP Slurry Vat Printing.

32. The method of claim 19, where the additive manufacturing comprises Ceramic LCM Printing.
